(19) United States
(12) Patent Application Publication
(10) Pub. No.: US 2026/0162396 A1
(43) Pub. Date: Jun. 11, 2026

(54) DEVICE AND A COMPUTER IMPLEMENTED METHOD FOR DETERMINING AT LEAST ONE SLICE OF A SET OF DIGITAL IMAGES ON WHICH A MODEL FOR DETECTING AN OBJECT IN A DIGITAL IMAGE UNDERPERFORMS

(71) Applicant: Robert Bosch GmbH, Stuttgart (DE)

(72) Inventors: Kaspar Sakmann, Stuttgart (DE); Dan Zhang, Leonberg (DE); Jan Hendrik Metzen, Bollingen (DE)

(21) Appl. No.: 19/407,808

(22) Filed: Dec. 3, 2025

(30) Foreign Application Priority Data
Dec. 11, 2024 (EP) 24 21 9188.0

(51) Int. Cl. G06V 10/25; G06T 9/00; G06V 20/70

(52) U.S. Cl. CPC G06V 10/25; G06T 9/00; G06V 20/70

(57) ABSTRACT

A device and a computer implemented method for determining at least one slice of a set of digital images on which a model for detecting an object in a digital image underperforms. Digital images are grouped into slices depending on embedding vectors that are determined for a respective patch that is determined for the respective digital images and depending on target values that are assigned to the respective embedding vector.

### CROSS REFERENCE

The present application claims the benefit under 35 U.S.C. § 119 of Europe Patent Application No. EP 24 21 9188.0 filed on Dec. 11, 2024, which is expressly incorporated herein by reference in its entirety.

### FIELD

The present invention relates to a device and a computer implemented method for determining at least one slice of a set of digital images on which a model for detecting an object in a digital image underperforms.

### BACKGROUND INFORMATION

Machine learning models deployed in the real-world must be routinely audited to identify subsets of data on which the models underperform. These subsets are termed slices; the process is often done manually and requires a significant amount of time.

### SUMMARY

A computer implemented method according to the present invention leverages the relationship between visual input and textual input to a vision language model in order to enable improvements in slice discovery. A low resolution of the dense visual features provided by the vision language model are upscaled to from the low resolution to the resolution of the visual input to resolve small objects.

According to an example embodiment of the present invention, the computer implemented method for determining at least one slice of a set of digital images on which a model for detecting an object in a digital image underperforms comprises providing a set of digital images, wherein the set of digital images comprises digital images that are respectively annotated with a ground truth bounding box label, wherein the ground truth bounding box label comprises bounding box coordinates and a class label, wherein the method further comprises determining, for the digital images, a respective prediction of the model, wherein the prediction of the model comprises a predicted bounding box label, wherein the predicted bounding box label comprises predicted bounding box coordinates and a predicted class label, determining, for the predictions that are determined for the digital images a respective patch of the respective digital image depending on the respective prediction, wherein the respective patch is a false positive patch or a false negative patch or a true positive patch, determining, for the patches, a respective encoding of the respective patch with an image encoder of a vision language model, wherein the image encoder is configured to encode visual input of a resolution, wherein the encoding of the respective patch comprises an encoding of the respective patch, and wherein the encoding of the respective patch comprises an encoding of dense visual features determined for the respective patch, determining, for the encodings of the dense visual features, a respective upscaled embedding of the same resolution as the visual input, determining, for the patches, a respective feature vector depending on the pixels of the patch that are inside the ground truth bounding box defined in the label for the digital image for that the patch is determined, determining, for the patches, a respective embedding vector depending on the feature vector determined for the respective patch and the encoding of the respective patch, assigning, to the embedding vectors a first target value or a second target value respectively, wherein the first target value is assigned to the respective embedding vector in case the patch that the respective embedding vector is determined for is a false positive patch, wherein the second target value is assigned to the respective embedding vector otherwise, in particular in case the patch that the respective embedding vector is determined for is a false negative patch or a true positive patch, grouping the digital images of the set of digital images into slices depending on the embedding vectors that are determined for the respective patch that is determined for the respective digital image and depending on the target values that are assigned to the respective embedding vector.

According to an example embodiment of the present invention, for determining a natural language description of at least one slice, the method comprises determining the natural language description of at least one slice depending on at least one feature vector that is determined for a patch that a digital image comprises that is grouped into the at least one slice.

According to an example embodiment of the present invention, determining the natural language description may comprise determining a plurality of feature vectors for the patch that the digital image comprises, determining an average feature vector of the plurality of feature vectors, determining, with a text encoder of the vision language model an embedding vector of the natural language description, and selecting the natural language description depending on a similarity between the embedding vector and the average feature vector.

The method may comprise receiving at least one digital image of the set of digital images, wherein the digital image is a video, a radar, a LiDAR, an ultrasound, a motion, or an infrared image.

In particular to mitigate using an output of the model, where the model underperforms, the method may comprise allowing to output at least one object that the model detects in at least one digital image that is outside of the at least one slice, or inhibiting to output at least one object that is detected in a digital image from the at least one slice.

In particular to use an output of the model, where the model underperforms, the method may comprise outputting the at least one slice of the set of digital images and/or the natural language description of the at least one slice.

The grouping may comprise assigning the target value to the embedding vector in an augmented vector, that comprises the embedding vector and the target value that is assigned to the embedding vector, and grouping the digital images depending on the augmented vector.

According to an example embodiment of the present invention, a device for determining at least one slice of a set of digital images on which a model for detecting an object in a digital image underperforms comprises at least one processor and at least one memory, wherein the at least one memory stores instructions that, when executed by the at least one processor, cause the device to execute the method of the present invention.

According to an example embodiment of the present invention, a computer program for determining at least one slice of a set of digital images on which a model for detecting an object in a digital image underperforms, characterized in that the computer program comprises computer-readable instructions that, when executed by the computer, cause the computer to execute the method of the present invention.

Further exemplary embodiments of the present invention are derived from the following description and the figures.

### BRIEF DESCRIPTION OF THE DRAWINGS

FIG. 1 schematically depicts a device for determining at least one slice of a set of digital images on which a model for detecting an object in a digital image underperforms, according to an example embodiment of the present invention.

FIG. 2 depicts a flow chart comprising steps of a method for determining at least one slice of the set of digital images on which the model underperforms, according to an example embodiment of the present invention.

FIG. 3 depicts an exemplary digital image.

FIG. 4 depicts exemplary dense features for the exemplary digital image.

FIG. 5 depicts an exemplary encoding of the dense features.

### DETAILED DESCRIPTION OF EXAMPLE EMBODIMENTS

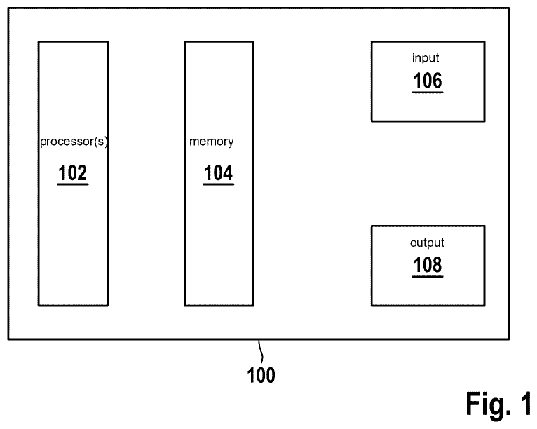

FIG. 1 schematically depicts a device 100 for determining at least one slice of a set of digital images on which a model for detecting an object in a digital image underperforms.

The device 100 comprises at least one processor 102, and at least one memory 104. The at least one processor 102 is configured to execute instructions that, when executed by the at least one processor 102 cause the device 100 to execute a method for determining at least one slice of the set of digital images on which the model for detecting an object in a digital image underperforms. The at least one memory 104 is configured to store the instructions.

The device 100 may comprise an input 106 that is configured to receive at least one digital image of the set of digital images. The input 106 may be an interface for receiving the digital image or a camera for capturing the digital image.

The digital image may be a video, a radar, a LiDAR, an ultrasound, a motion, or an infrared image.

The device 100 may be configured to determine a natural language description of the at least one slice.

The device 100 may be configured to output at least one object that the model detects in a digital image. The device 100 may be configured to disregard at least one object that is detected in a digital image from the at least one slice.

The device 100 may be configured to output the at least one slice of the set of digital images and/or the natural language description of the at least one slice.

The device 100 may be configured to allow the output of at least one object detected in at least one digital image that is outside of the at least one slice of the set of digital images. The device 100 may be configured to inhibit the output of at least one object detected in at least one digital image that is in the at least one slice of the set of digital images.

The device 100 may comprise an output 108. The output 108 may be an interface for sending a digital image that is outside of the at least one slice or an object that is detected in a digital image that is outside of the at least one slice. The output 108 may be an interface for sending the natural language description of a slice in particular associated with at least one digital image that is inside the slice.

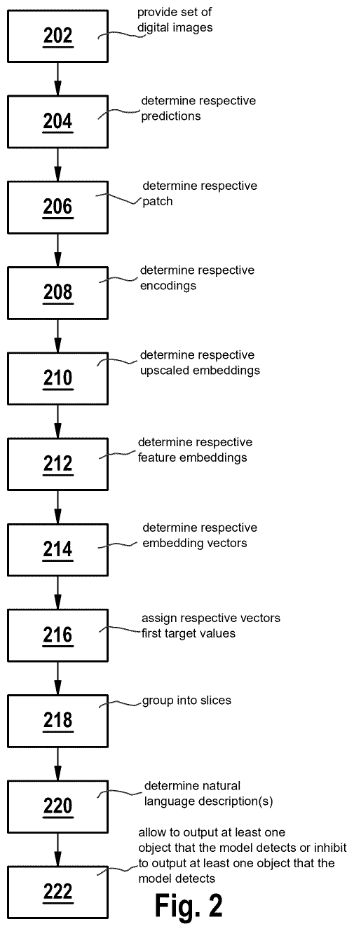

FIG. 2 depicts a flow chart comprising steps of the method.

The method is based on a given model f(x) for detecting an object in a digital image.

The model f(x) is configured to determine a prediction ŷ depending on visual input. The visual input in the example comprises a digital image X∈[0,1]^{H×W×C}, wherein H defines the height of the digital image, W defines the width of the digital image, and C defines the dimension of the color channel. According to the example, the digital image x comprises pixels, H defines the number of rows of pixels in the digital image and W defines the number of columns of pixels in the digital image. For a monocromatic digital image C defines a single dimension, for an image according to the RGB color model, C defines three dimensions of the color channel, red, green, blue.

The prediction ŷ comprises a bounding box label. According to an example, the bounding box label ŷ comprises four predicted bounding box coordinates (\hat{x}₀,ŷ₀,\hat{x}₁,ŷ₁) and a predicted class label ĉ. The four predicted bounding box coordinates (\hat{x}₀,ŷ₀,\hat{x}₁,ŷ₁) define a subset of pixels of the digital digital image x that, according to the prediction ŷ comprises the object. The predicted class label ĉ defines the class of the object. According to an example, the model f is configured to determine the predicted class label ĉ from a set of n_{c-1} given class labels cᵢ, i∈(0, 1, 2, . . . , n_{c-1}) that the model f is trained to detect.

The model f may be configured to determine a confidence score sᵢ∈[0,1] for the prediction ŷ. The confidence score sᵢ for the prediction ŷ indicates the confidence that the prediction ŷ is correct.

The method is based on a given transformer based vision language model with a common embedding space for the vision input and for language input. An example for the transformer based vision language model is Contrastive Language-Image Pre-training, CLIP. CLIP is for example, described in “Learning Transferable Visual Models From Natural Language Supervision” (arXiv:2103.00020v1). The method is not restricted to working with a transformer based vision language model. The method may be based on another vision language model with a common embedding space for vision and language inputs.

The vision language model comprises an image encoder E_{img}(·) and a text encoder Eₜₑₓₜ(·). The vision language model is configured to output an encoding I^{glob} of the visual input and an encoding I^{dense} of dense visual features, where I^{glob}∈ [symbol] ^{1×p} and I^{dense}∈ [symbol] ^{h×h×p}, and where h and p are parameters. Exemplary values are h=16, p=512. This means, the spatial resolution of the dense features is reduced by a factor of 14 compared to an exemplary input resolution for the visual input of 224×224 pixel. The method is not limited to the exemplary values of the parameters. The method is not limited to the exemplary input resolution.

For CLIP, the encoding I^{glob} of the visual input is the “cls” token determined for the visual input and the encoding I^{dense} of dense visual features is the CLIP embedding determined for the visual input.

The method comprises a step 202.

In the step 202, a set of digital images Dᵥₐₗ=(X,Y)={(xᵢ,yᵢ)}_{i=1, . . . , n}_{_{gt}} is provided.

The set of digital images Dᵥₐₗ comprises n_{gt} digital images xᵢ∈[0,1]^{H×W×C} that are respectively annotated with a ground truth bounding box label yᵢ. According to the example, the ground truth bounding box label yᵢ comprises four bounding box coordinates (x₀,y₀,x₁,y₁)ᵢ and a class label cᵢ.

The method is described by way of an example for a single class label c. The method is not limited to using the single class label c and can be carried out for more than one class label, in particular for all class labels of the set of n_{c-1} given class labels.

According to the example, the method comprises collecting the digital images xᵢ from the set of digital images Dᵥₐₗ where cᵢ=c. According to the example, n_{pred} digital images xᵢ are collected from the set of digital images Dᵥₐₗ where cᵢ=c.

This means, the digital images digital images xᵢ from the set of digital images Dᵥₐₗ are associated with the given class label c.

Instead of collecting the digital images, the method may comprise providing the set of digital images Dᵥₐₗ comprising only digital images xᵢ associated with the given class label c.

This means, the method comprises providing digital images associated with the given class label c.

The method for example comprises receiving at least one digital image of the set of digital images.

The digital images are for example video, radar, LiDAR, ultrasound, motion, or infrared images.

The method comprises a step 204.

In the step 204, for the digital images xᵢ that are associated with the given class label c, a respective prediction ŷᵢ of the model f is determined.

For example, a set of n_{pred} predictions Ŷ={ŷᵢ}_{i=1, . . . , n}_{_{pred}} is determined. The set of predictions Ŷ comprises, for the digital images xᵢ that are associated with the given class label c, a respective prediction ŷᵢ of the model f.

The method comprises a step 206.

In the step 206, for the predictions ŷᵢ that are determined for the digital images xᵢ that are associated with the given class label c, a respective patch wᵢ is determined depending on the respective prediction ŷᵢ.

For example a set of nₜₚ true positive patches

$${W}_{tp} = {\{ ( {w}_{j}^{tp} , {z}_{j}^{tp} ) \}}_{j = 1 , … , {n}_{tp}}$$

is determined, wherein

$${w}_{j}^{tp}$$

represents the coordinates

$${( {x}_{0} , {y}_{0} , {x}_{1} , {y}_{1} )}_{j}^{tp}$$

of the true positive patch in the digital image xⱼ for that the patch is determined, and wherein

$${z}_{j}^{tp}$$

represents the coordinates (x₀,y₀,x₁,y₁)ⱼ of the ground truth bounding box defined in the label yⱼ for the digital image xⱼ for that the patch is determined, relative to

$${w}_{j}^{tp} .$$

For example a set of n_{fp} false positive patches

$${W}_{fp} = {\{ ( {w}_{j}^{fp} , {z}_{j}^{fp} ) \}}_{j = 1 , ... , {n}_{fp}}$$

is determined, wherein

$${w}_{j}^{fp}$$

represents the coordinates

$${( {x}_{0} , {y}_{0} , {x}_{1} , {y}_{1} )}_{j}^{fp}$$

of the false positive patch in the digital image xⱼ for that the patch is determined, and wherein

$${z}_{j}^{fp}$$

represents the coordinates (x₀,y₀,x₁,y₁)ⱼ of the ground truth bounding box defined in the label yⱼ for the digital image xⱼ for that the patch is determined relative to

$${w}_{j}^{fp} .$$

For example a set of n_{fn} false negative patches

$${W}_{fn} = {\{ ( {w}_{j}^{fn} , {z}_{j}^{fn} ) \}}_{j = 1 , ... , {n}_{fn}}$$

is determined, wherein

$${w}_{j}^{fn}$$

represents the coordinates

$${( {x}_{0} , {y}_{0} , {x}_{1} , {y}_{1} )}_{j}^{fn}$$

of the false negative patch in the digital image xⱼ for that the patch is determined, and wherein

$${z}_{j}^{fn}$$

represents the coordinates (x₀,y₀,x₁,y₁)ⱼ of the ground truth bounding box defined in the label yⱼ for the digital image xⱼ for that the patch is determined relative to

$${w}_{j}^{fn} .$$

The patches wⱼ in the set of true positive patches Wₜₚ, the set of false positive patches W_{fp}, and the set of false negative patches W_{fn} are determined to comprise the bounding box \tilde{w}ⱼ defined by the bounding box coordinates (\hat{x}₀,ŷ₀,\hat{x}₁,ŷ₁) of the prediction ŷⱼ that the model f outputs for the digital image xⱼ for that the patch is determined:

$${\tilde{w}}_{j} ⊆ {w}_{j}$$

The bounding box \tilde{w}ⱼ is for example determined with the Hungarian method as described in Harold W. Kuhn, “The Hungarian Method for the assignment problem”, Naval Research Logistics Quarterly, 2: 83-97, 1955.

Whether a patch wᵢ is a false positive patch

$${\tilde{w}}_{i}^{fp} ,$$

a false negative patch

$${\tilde{w}}_{i}^{fn} ,$$

or a true positive patch

$${\tilde{w}}_{i}^{tp}$$

is for example determined using intersection over union of the bounding box \tilde{w}ⱼ according to the prediction ÿⱼ and the ground truth bounding box defined in the label yⱼ for the digital image xⱼ for that the patch is determined, as a score for distinguishing a true positive detection from a false detection.

For the model f that is configured to output the confidence score sᵢ, the method may comprise filtering out a prediction ŷᵢ for that the confidence score sᵢ is smaller than a threshold sₜₕᵣ: sᵢ<sₜₕᵣ.

At this point, the size of the patches may be arbitrary, or the patches may have a size and resolution of the visual input of the vision language model.

A patch that has a different size or resolution than the visual input of the vision language model, may be processed to have the resolution of the visual input of the vision language model.

For example, the patch is scaled to the resolution of the visual input of the vision language model.

An example for the visual input is a rectangular patch, in particular a square patch, of a given resolution. The resolution for the square patch is for example 224×224 pixel, i.e., a square area with H=W=224 pixel.

The method may comprise selecting the rectangular area of the given resolution of the digital image xⱼ for that the patch is determined as the patch. The method may comprise selecting the square area of the given resolution, e.g., of 224×224 pixel, of the digital image xⱼ for that the patch is determined as the patch.

The bounding box according to the prediction ŷᵢ or the ground truth bounding box may be larger than the visual input, e.g., larger than the rectangular area of the given resolution. The method may comprise selecting a rectangular area that is larger than the visual input, e.g. larger than the rectangular area of the given resolution, of the digital image xⱼ for that the patch is determined. The method may comprise scaling down the larger area to the patch having the given resolution.

The bounding box according to the prediction ŷᵢ or the ground truth bounding box may be smaller than the visual input, e.g., smaller than the rectangular area of the given resolution. The method may comprise selecting a rectangular area that is smaller than the visual input, e.g. smaller than the rectangular area of the given resolution, of the digital image xⱼ for that the patch is determined. The method may comprise scaling up the smaller area to the patch having the given resolution.

The method comprises a step 208.

In the step 208, for the patches wᵢ a respective encoding

$${E}_{img} ( {w}_{i} ) = {I}_{i}^{glob} , {I}_{i}^{dense}$$

of the respective patch wᵢ is determined with the image encoder E_{img}(·) of the vision language model. The encoding comprises the encoding

$${I}_{i}^{glob}$$

of the patch wᵢ. For CLIP, the encoding I^{glob} of the patch is the “cls” token determined for the patch wᵢ. The encoding comprises the encoding

$${I}_{i}^{dense}$$

of dense visual features determined for the patch wᵢ. For CLIP, the encoding

$${I}_{i}^{dense}$$

of dense visual features for the patch wᵢ is the CLIP embedding of the dense visual features determined for the patch wᵢ.

The method comprises a step 210.

In the step 210, for the encodings

$${I}_{i}^{dense}$$

of dense visual features, a respective upscaled embedding

$${I}_{i}^{featup}$$

of the same resolution as the visual input is determined. The upscaled embedding

$${I}_{i}^{featup}$$

of the same resolution as the visual input is determined using a FeatUp upscaler

$$FeatUp ( \begin{matrix}. . \\ ,\end{matrix} ) : {h \times h \times p}^{} \times {H \times H \times C}^{} \to {H \times H \times p}^{}$$

as described in Fu et al., “FeatUp: A Model-Agnostic Framework for Features at Any Resolution,” ICLR 2024 (arXiv:2403.10516v2).

The FeatUp upscaler FeatUp(·,·) is configured to map from the low spatial resolution embedding space for the encoding

$${I}_{i}^{dense}$$

of dense visual features into an embedding space of the same spatial dimension H×H as the visual input and as the patch wᵢ. The input patch wᵢ is used as guidance for upsampling:

$$FeatUp ( {I}_{i}^{dense} , {w}_{i} ) = {I}_{i}^{featup} ∈ {H \times H \times p}^{}$$

The method comprises a step 212.

In the step 212, for the patches wᵢ, a respective feature vector

$${I}_{i}^{obj}$$

is determined. The feature vector

$${I}_{i}^{obj}$$

represents the pixels of the patch wᵢ that are inside the ground truth bounding box defined in the label yᵢ for the digital image xᵢ for that the patch wᵢ is determined. The feature vector

$${I}_{i}^{obj}$$

represents an object embedding of an object in the ground truth bounding box.

The feature vector

$${I}_{i}^{obj}$$

is for example determined from a binary mask

$$m = I ( inside {z}_{i} )$$

that associates the pixels of the patch wᵢ that are inside the ground truth bounding box coordinates, represented by zᵢ, with the binary value True, e.g., 1, and pixels of the patch wᵢ outside the ground truth bounding box coordinates with the binary value False, e.g., 0. The feature vector

$${I}_{i}^{obj}$$

∈ [symbol] ^{2p} is for example determined by averaging the feature vectors corresponding to pixels inside the ground truth bounding box

$${I}_{i}^{obj} = \frac{1}{\vert \{ k ∈ bbox \} \vert} {\sum }_{k ∈ bbox} m * {I}_{i}^{featup}$$

wherein bbox represents the ground truth bounding box and * the element-wise product of the matrix m with the encoding

$${I}_{i}^{dense}$$

of dense visual features.

The method comprises a step 214.

In the step 214, for the patches wᵢ, a respective embedding vector

$${I}_{i}^{tot}$$

is determined depending on the feature vector

$${I}_{i}^{obj}$$

determined for the respective patch wᵢ and the encoding

$${I}_{i}^{glob}$$

of the respective patch wᵢ.

For example, the feature vector

$${I}_{i}^{obj}$$

determined for the respective patch wᵢ is concatenated with the respective encoding

$${I}_{i}^{glob}$$

of the respective patch wᵢ to yield the respective embedding vector

$${I}_{i}^{tot} = [ {I}_{i}^{glob} \vert {I}_{i}^{obj} ]$$

The method comprises a step 216.

In the step 216, for the embedding vectors

$${I}_{i}^{tot} ,$$

the respective embedding vector

$${I}_{i}^{tot}$$

is assigned a first target value, e.g., t=0, in case the respective embedding vector

$${I}_{i}^{tot}$$

is determined for a patch wᵢ that is a false positive patch

$${\tilde{w}}_{i}^{fp}$$

and a second target value, e.g., t=1, otherwise, e.g., in case the respective embedding vector

$${I}_{i}^{tot}$$

is determined for a patch wᵢ that is a false negative patch

$${\tilde{w}}_{i}^{fn}$$

or a true positive patch

$${\tilde{w}}_{i}^{tp} .$$

The target value is assigned to the embedding vector

$${I}_{i}^{tot}$$

for example in an augmented vector, that comprises the embedding vector

$${I}_{i}^{tot}$$

and the target value that is assigned to the embedding vector

$${I}_{i}^{tot} .$$

An exemplary augmented vector

$${v}_{k}^{FP}$$

for a false positive detection comprises the first target value, e.g.:

$${v}_{k}^{FP} = ( {I}_{i}^{tot} , 0 )$$

An exemplary augmented vector

$${v}_{k}^{TP}$$

for a true positive detection comprises the second target value, e.g.:

$${v}_{k}^{TP} = ( {I}_{i}^{tot} , 1 )$$

An exemplary augmented vector

$${v}_{k}^{FN}$$

for a false negative detection comprises the second target value, e.g.:

$${v}_{k}^{FN} = ( {I}_{i}^{tot} , 1 )$$

The method comprises a step 218.

In the step 218, the digital images xᵢ of the set of digital images Dᵥₐₗ are grouped into slices depending on the embedding vectors

$${I}_{i}^{tot}$$

that are determined for the respective patch wᵢ that is determined for the respective digital image xᵢ and depending on the target values that are assigned to the respective embedding vector

$${I}_{i}^{tot} .$$

The digital images xᵢ are grouped for example into a predefined number n of slices.

The digital images xᵢ are grouped, for example, into the slices depending on the augmented vectors.

For example, the augmented vectors are clustered into n clusters, wherein the clusters map to the slices one by one.

This yields coherent slices, i.e., slices that comprise digital images xᵢ that share a common human-understandable trait.

For instance, in the context of autonomous driving a slice contains images of cars of a certain type, absent in the training set.

The digital images xᵢ are grouped, for example, into the slices additionally depending on the confidence scores sᵢ.

The digital images xᵢ are grouped for example into the slices with the Domino clustering algorithm. The Domino clustering algorithm is described for example in Eyuboglu et al., “Domino: Discovering Systematic Errors with Cross-Modal Embeddings”, ICLR 2022, (arXiv:2183.14960v3).

The method comprises a step 220.

In the step 220, a natural language description of at least one slice is determined depending on at least one feature vector

$${I}_{i}^{obj}$$

that is determined for a patch wᵢ that a digital image xᵢ comprises that is grouped into the at least one slice.

The natural language description of at least one slice is determined, for example, as described in Domino: Discovering Systematic Errors with Cross-Modal Embeddings.

The method is not limited to determining the natural language description of the at least one slice as described in Domino: Discovering Systematic Errors with Cross-Modal Embeddings. A different slice description method may be used as well.

Determining the natural language description is described for an exemplary slice.

Determining the natural language description is described for the exemplary slice comprises averaging the feature vectors

$${I}_{i}^{obj}$$

that are determined for the patches wᵢ that are grouped into the exemplary slice to yield an averaged feature vector. Determining the natural language description for the exemplary slice comprises providing a phrase comprising a template for a property of an object and a template for the class of the object. An example for the phrase is “a <lighting> photo of a <class>”, where lighting is the template for the property and <class> is the template for the class label.

Determining the natural language description for the exemplary slice comprises replacing the template for the property in the phrase with a property from a set of predetermined properties. An exemplary set of predetermined properties for the template <lighting> is “dark”, “bright”.

Determining the natural language description for the exemplary slice comprises replacing the template for the class in the phrase with one of the class labels cᵢ, i∈(0, 1, 2, . . . , n_{c-1}). An exemplary set of class labels for the template <class> is “pedestrian”, “car”, “bike”.

Replacing the templates in the phrase yields an instance of the phrase.

Determining the natural language description for the exemplary slice comprises, a plurality of instances of the phrase by replacing the template for the property with different values from the set of predetermined properties and/or by replacing the template for the class with different values from the set of class labels.

The instances are respectively mapped with the text encoder Eₜₑₓₜ(·) to the embedding space to yield respective text embedding vectors.

Then the text embedding vector that is most similar to the average feature vector is determined and the instance of the phrase that is mapped to the text embedding vector that is most similar to the average feature vector is determined as the natural language description for the exemplary slice.

For example, a respective cosine similarity is determined between the average feature vector and the text embedding vectors that are determined for the instances respectively. The text embedding vector most similar to the average feature vector is for example determined depending on the cosine similarities between the average feature vector and the text embedding vectors that are determined for the instances.

The method may comprise a step 222.

The step 222 may comprise allowing to output at least one object that the model detects in at least one digital image that is outside of the at least one slice, or inhibiting to output at least one object that is detected in a digital image from the at least one slice.

The step 222 may comprise to output the at least one slice of the set of digital images and/or the natural language description of the at least one slice.

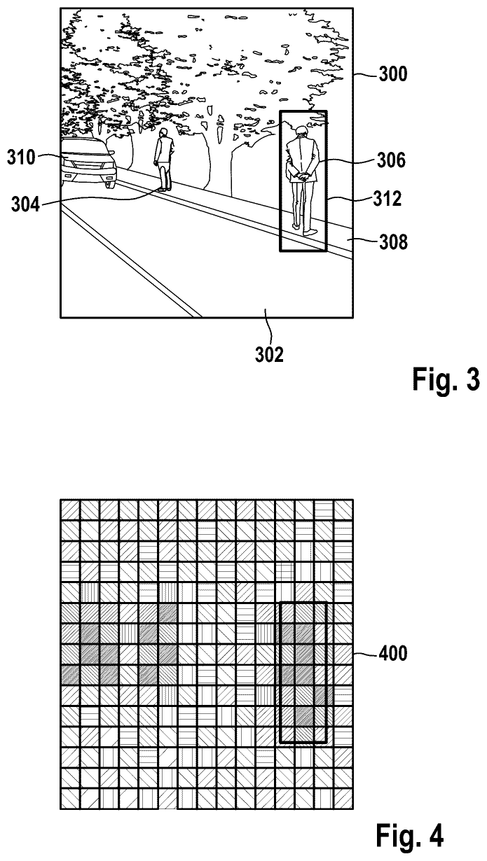

FIG. 3 depicts an exemplary digital image 300.

The exemplary digital image 300 depicts a real world scenario captured in the real world, e.g. by a sensor that is mounted to a vehicle.

The exemplary digital image 300 depicts a road 302 and a first pedestrian 304 and a second pedestrian 306 on a walkway 308. A part of a vehicle 310 that is located on the road 302 next to the pedestrians 304, 306 is depicted in the exemplary picture 300 as well.

FIG. 3 shows a bounding box 312 around the second pedestrian 306 as true positive detection of a pedestrian.

FIG. 4 depicts the dense features 400 that the image encoder E_{img}(·) outputs for the exemplary digital image 300. The dense features are of very low resolution.

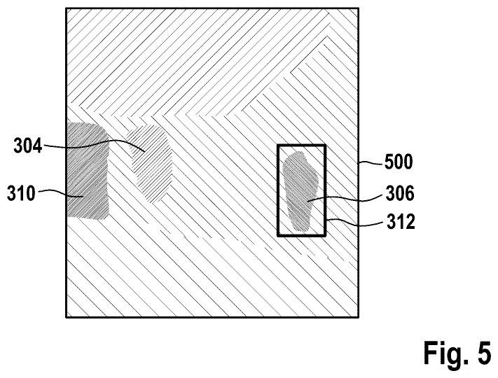

FIG. 5 depicts the encoding

$${I}_{i}^{featup}$$

determined for the dense features 400 with the FeatUp upscaler FeatUp(·,·). FIG. 5 depicts the bounding box 312 around the upscaled features of the encoding

$${I}_{i}^{featup}$$

that represent the second pedestrian 306. According to the example, the upscaled features representing the first pedestrian 304 and the part of the vehicle 310 are recognizable in FIG. 5 as well.

What is claimed is:

1. A computer implemented method for determining at least one slice of a set of digital images on which a model for detecting an object in a digital image underperforms, the method comprising the following steps:
providing a set of digital images, wherein the set of digital images includes digital images that are each respectively annotated with a ground truth bounding box label, wherein each of the ground truth bounding box labels includes bounding box coordinates and a class label;
determining, for each respective digital image of the digital images, a respective prediction of the model, wherein each of the respective predictions of the model includes a predicted bounding box label, wherein the predicted bounding box label includes predicted bounding box coordinates and a predicted class label;
determining, for each of the respective predictions that are determined for the respective digital images, a respective patch of the respective digital image depending on the respective prediction, wherein the respective patch is a false positive patch or a false negative patch or a true positive patch;
determining, for each of the respective patches, a respective encoding of the respective patch with an image encoder of a vision language model, wherein the image encoder is configured to encode visual input of a resolution, wherein the encoding of the respective patch includes an encoding of the respective patch, and wherein the encoding of the respective patch includes an encoding of dense visual features determined for the respective patch;
determining, for the encodings of the dense visual features, a respective upscaled embedding of the same resolution as the visual input;
determining, for each of the patches, a respective feature vector depending on pixels of the patch that are inside the ground truth bounding box defined in the label for the respective digital image for which the patch is determined;
determining, for each respective patch of the patches, a respective embedding vector depending on the feature vector determined for the respective patch and the encoding of the respective patch;
assigning, to each of the embedding vectors, a first target value or a second target value respectively, wherein the first target value is assigned to the respective embedding vector when the respective patch for which the respective embedding vector is determined is a false positive patch, wherein the second target value is assigned to the respective embedding vector when the respective patch for which the respective embedding vector is determined is a false negative patch or a true positive patch; and
grouping the digital images of the set of digital images into slices depending on the respective embedding vectors that are determined for the respective patches which are determined for the respective digital images and depending on the first or second target values that are assigned to the respective embedding vectors.

2. The method according to claim 1, further comprising:
determining a natural language description of at least one slice of the slices depending on at least one feature vector that is determined for a patch which a digital image includes that is grouped into the at least one slice.

3. The method according to claim 2, wherein the determining of the natural language description includes:
determining a plurality of feature vectors for the patch that the digital image includes;
determining an average feature vector of the plurality of feature vectors;
determining, with a text encoder of the vision language model, an embedding vector of the natural language description; and
selecting the natural language description depending on a similarity between the embedding vector and the average feature vector.

4. The method according to claim 1, further comprising:
receiving at least one digital image of the set of digital images, wherein the received at least one digital image is a video image or a radar image or a LiDAR image or an ultrasound image or a motion image or an infrared image.

5. The method according to claim 1, further comprising:
allowing outputting of at least one object that the model detects in at least one digital image that is outside of the at least one slice, or inhibiting outputting of at least one object that is detected in a digital image from the at least one slice.

6. The method according to claim 2, further comprising:
outputting the at least one slice of the set of digital images and/or the natural language description of the at least one slice.

7. The method according to claim 1, wherein the grouping includes assigning the first or second target value to each of the embedding vectors in a respective augmented vector that includes the embedding vector and the first or second target value that is assigned to the embedding vector, and grouping the digital images depending on the augmented vectors.

8. A device for determining at least one slice of a set of digital images on which a model for detecting an object in a digital image underperforms, the device comprising:
at least one processor; and
at least one memory, wherein the at least one memory stores instructions that, when executed by the at least one processor, cause the device to execute a method including the following steps:
providing a set of digital images, wherein the set of digital images includes digital images that are each respectively annotated with a ground truth bounding box label, wherein each of the ground truth bounding box labels includes bounding box coordinates and a class label,
determining, for each respective digital image of the digital images, a respective prediction of the model, wherein each of the respective predictions of the model includes a predicted bounding box label, wherein the predicted bounding box label includes predicted bounding box coordinates and a predicted class label,
determining, for each of the respective predictions that are determined for the respective digital images, a respective patch of the respective digital image depending on the respective prediction, wherein the respective patch is a false positive patch or a false negative patch or a true positive patch,
determining, for each of the respective patches, a respective encoding of the respective patch with an image encoder of a vision language model, wherein the image encoder is configured to encode visual input of a resolution, wherein the encoding of the respective patch includes an encoding of the respective patch, and wherein the encoding of the respective patch includes an encoding of dense visual features determined for the respective patch,
determining, for the encodings of the dense visual features, a respective upscaled embedding of the same resolution as the visual input,
determining, for each of the patches, a respective feature vector depending on pixels of the patch that are inside the ground truth bounding box defined in the label for the respective digital image for which the patch is determined,
determining, for each respective patch of the patches, a respective embedding vector depending on the feature vector determined for the respective patch and the encoding of the respective patch,
assigning, to each of the embedding vectors, a first target value or a second target value respectively, wherein the first target value is assigned to the respective embedding vector when the respective patch for which the respective embedding vector is determined is a false positive patch, wherein the second target value is assigned to the respective embedding vector when the respective patch for which the respective embedding vector is determined is a false negative patch or a true positive patch, and
grouping the digital images of the set of digital images into slices depending on the respective embedding vectors that are determined for the respective patches which are determined for the respective digital images and depending on the first or second target values that are assigned to the respective embedding vectors.

9. A non-transitory computer-readable medium on which is stored a computer program including computer-readable instructions for determining at least one slice of a set of digital images on which a model for detecting an object in a digital image underperforms, the instructions, when executed by a computer, causing the computer to perform the following steps comprising:
providing a set of digital images, wherein the set of digital images includes digital images that are each respectively annotated with a ground truth bounding box label, wherein each of the ground truth bounding box labels includes bounding box coordinates and a class label;
determining, for each respective digital image of the digital images, a respective prediction of the model, wherein each of the respective predictions of the model includes a predicted bounding box label, wherein the predicted bounding box label includes predicted bounding box coordinates and a predicted class label;
determining, for each of the respective predictions that are determined for the respective digital images, a respective patch of the respective digital image depending on the respective prediction, wherein the respective patch is a false positive patch or a false negative patch or a true positive patch;
determining, for each of the respective patches, a respective encoding of the respective patch with an image encoder of a vision language model, wherein the image encoder is configured to encode visual input of a resolution, wherein the encoding of the respective patch includes an encoding of the respective patch, and wherein the encoding of the respective patch includes an encoding of dense visual features determined for the respective patch;
determining, for the encodings of the dense visual features, a respective upscaled embedding of the same resolution as the visual input;
determining, for each of the patches, a respective feature vector depending on pixels of the patch that are inside the ground truth bounding box defined in the label for the respective digital image for which the patch is determined;
determining, for each respective patch of the patches, a respective embedding vector depending on the feature vector determined for the respective patch and the encoding of the respective patch;
assigning, to each of the embedding vectors, a first target value or a second target value respectively, wherein the first target value is assigned to the respective embedding vector when the respective patch for which the respective embedding vector is determined is a false positive patch, wherein the second target value is assigned to the respective embedding vector when the respective patch for which the respective embedding vector is determined is a false negative patch or a true positive patch; and
grouping the digital images of the set of digital images into slices depending on the respective embedding vectors that are determined for the respective patches which are determined for the respective digital images and depending on the first or second target values that are assigned to the respective embedding vectors.
